(19) United States
(12) Patent Application Publication
(10) Pub. No.: US 2007/0288268 A1
(43) Pub. Date: Dec. 13, 2007

(54) Adaptable Electronic Medical Record System and Method

(76) Inventor: Walter L. Weeks, Marietta, GA (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/740,760

(22) Filed: Apr. 26, 2007

Related U.S. Application Data
(60) Provisional application No. 60/799,366, filed on May 11, 2006.

(51) Int. Cl. G06F 19/00

(52) U.S. Cl. 705/3

(57) ABSTRACT

An electronic medical records system is implemented in spreadsheet software utilizing an electronic master patient form adaptable to a physician preferences, storing patient records in that form in an electronic folder and interacting with software modules to automate physician office administrative tasks.

### RELATED U.S. APPLICATION DATA

The present application is a continuation-in-part of U.S. Ser. No. 11/(?) (no filing receipt returned) filed about June, 2006 entitled Sapphire Electronic Medical Record, and claims priority to U.S. Provisional Application No. 60/799,366 filed May 11, 2006, said prior applications being incorporated herein by reference in their entirety.

### FIELD OF THE INVENTION

The invention relates to electronic medical records (EMR) or electronic health records (EHR), and more specifically to an EMR system for capturing, storing, processing and transmitting a patient's medical or health-related information in a fashion that is efficient and economical both for the health care provider and for third party payors and data processors.

### BACKGROUND OF THE INVENTION

Medical record keeping requires accuracy to assist in the immediate evaluation and historical recordation of patient medical conditions, and efficiency to minimize the loss of valuable health professionals' time to administration and paperwork. Literally billions of pages of medical records are generated every year in the United States. Paper records are likely to contain mistakes, they are expensive to process, they may be easily misread, they require substantial storage space, and they can be difficult to access quickly. These shortcomings may have serious consequences resulting in less than optimal patient treatment and may also impede prompt and accurate financial processing.

To address the shortcomings of paper records, many electronic medical record (EMR) technologies have emerged. These prior art EMR technologies are generally expensive to develop, purchase and deploy. Most prior art EMR technologies are largely proprietary systems that either require physician practices to adapt their practices to conform to the structure and operation of the EMR system, or require such expensive modifications to the EMR system that implementation is not practical for small group practices. The inflexibility of these proprietary EMR systems thus impose the burden that an implementing medical practice change its business processes and work flow to accommodate the software.

Furthermore, many prior art EMR systems rely upon access to remote databases. For instance the provider of the EMR system may maintain a commercial database accessible by internet communication for a group of physician practices. This leads to a situation where in the absence of communication capabilities with the remote database, no historical information is readily accessible to each of the physician practices. Alternatively, much more expensive EMR systems may include dedicated servers and storage devices to operate database software within a physician practice. However, this frequently causes the complexity of the information processing system at the physician's office to become so complex as to require full-time support staff to maintain the network and database, over and above the high initial costs of such systems. Finally, the implementation of many prior art EMR systems requires physicians and their staff to learn entirely new software applications. This learning curve hinders operational efficiencies for weeks or months when a new system is implemented. Proprietary database formats also hinder the ability of a practice group to subsequently transition to an alternative system or to easily communicate data to third parties.

### OBJECTS OF THE INVENTION

Therefore, it is an object of the invention to provide an EMR system that is adaptable to the patient evaluation and business processes that currently exist across a variety of physician practices.

It is another object of the invention to provide interfaces to the system so that it operates with commonly used office productivity software typified by Microsoft Office products such as Excel and Word.

It is yet another object of the invention to provide an EMR system that is fully functional without access to remote database, yet may utilize remote data storage for archival purposes.

These and other objects of the invention are accomplished by utilization of an ad-in module to operate within Microsoft Excel or similar standard spreadsheet software, conforming the appearance of spreadsheet documents to paper forms utilized by a physician practice, and the implementation of software modules or scripts and remote desktop applications all as explained in more detail below.

### BRIEF DESCRIPTION OF THE DRAWINGS

FIG. 1 is an illustration of a portion of a representative patient encounter form.

FIG. 2 illustrates an overview of exemplary EMR system menu choices presented to a user.

FIG. 3A is a screen shot of a representative patient encounter form for use in an EMR system according to the invention.

FIG. 3B is a screen shot of an exemplary bill sheet to capture patient billing information for use in an EMR system according to the invention.

FIG. 3C is a screen shot of a representative prescription data sheet for use in an EMR system according to the invention.

FIG. 3D is a screen shot of a representative patient treatment data sheet for infusion therapy for use in an EMR system according to the invention.

FIG. 3E is a screen shot of an exemplary patient health assessment questionnaire data sheet for use in an EMR system according to the invention.

FIG. 3F is a screen shot of an exemplary MRI data sheet for use in an EMR system according to the invention.

FIG. 4 is a flow chart illustrating a process for updating master patient EMR files.

FIG. 5 is a flow chart illustrating a process for creating a distribution list and distributing patient information electronically.

FIG. 6A is a flow chart illustrating a process for adding a medication to a patient's EMR.

FIG. 6B is a screen shot of a representative data entry template to add a medication for use in an EMR system according to the invention.

FIG. 7 is a flow chart illustrating a process for validating medications for interactions and allergies.

FIG. 8 is a flow chart illustrating a process for creating a note for a patient record.

FIG. 9 is a flow chart illustrating a process for sending a note from a patient's EMR.

FIG. 10 is a flow chart illustrating a process for creating and sending a letter from a patient's EMR.

FIG. 11 is a flow chart illustrating a process for transmitting a patient's prescription to a pharmacy.

FIG. 12 is a flow chart illustrating a process for building a patient bill.

FIG. 13 is a flow chart illustrating a process for notifying personnel within the physician practice of pending work.

FIG. 14A is a flow chart illustrating a process for creating a document with MRI results.

FIG. 14B is a flow chart illustrating a process for creating a document with MRI results where data is stored within the electronic MRI image file.

FIG. 15 is a flow chart illustrating a process for adding a new pharmacy to the EMR system's contact records and to a patient's EMR.

FIG. 16 is a flow chart illustrating a process for clearing previous billing information.

FIG. 17 is a schematic illustration of a process for data backup for an EMR system according to the invention.

FIG. 18 is a flow chart illustrating a process for updating contact information across the work stations in a physician's practice utilizing an EMR system according to the invention.

FIG. 19 is a flow chart illustrating a process for updating computers on a local area network for an EMR system according to the invention.

FIG. 20 is a flow chart illustrating a process for receiving lab reports transmitted from an outside laboratory into the EMR system.

FIG. 21 is a flow chart illustrating a process for filing lab reports to individual patient records within the EMR system.

FIG. 22 is a flow chart illustrating an auto send process to transmit lab result to patients from the EMR system.

FIG. 23 is a flow chart illustrating a process for acquiring, utilizing and updating drivers license and insurance card data for use in the EMR system.

FIG. 24 is a flow chart illustrating a process for utilizing voice recognition software in connection with the EMR system.

FIG. 25 is a flow chart illustrating a process for faxing information from the EMR system.

FIG. 26 is a flow chart illustrating a process for adapting a handheld device to run applications on a work station running the EMR system.

FIG. 27 is a flow chart illustrating a process for communicating information from records within the EMR system and the DOQ-IT data warehouse.

### DETAILED DESCRIPTION OF THE INVENTION

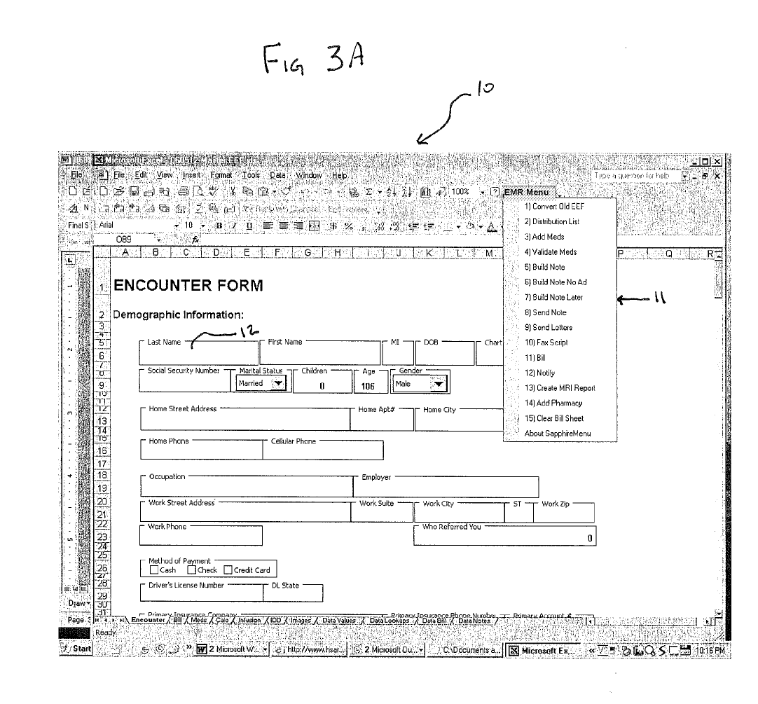

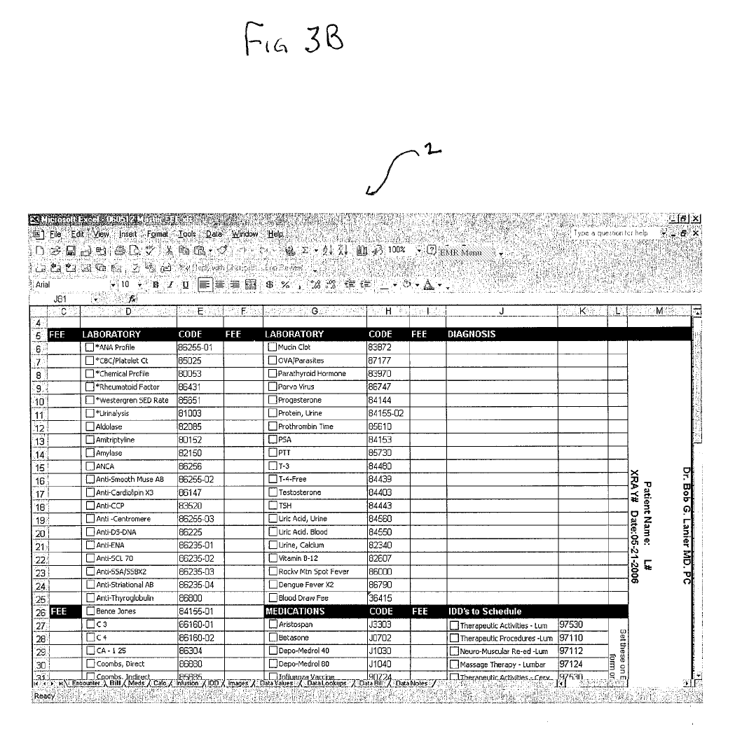

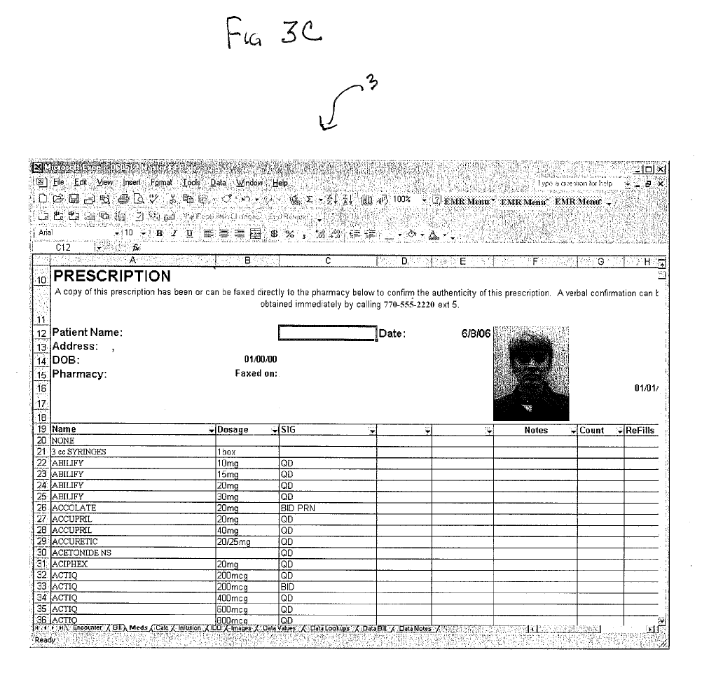

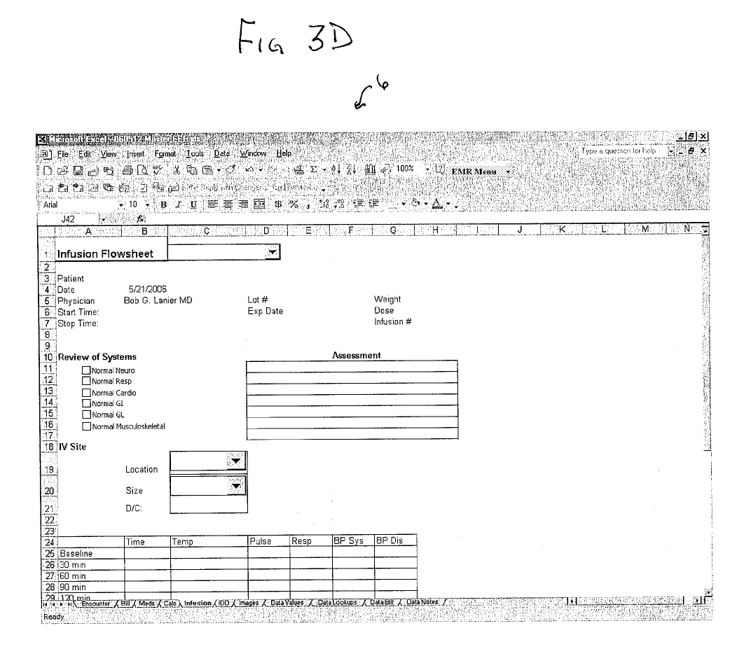

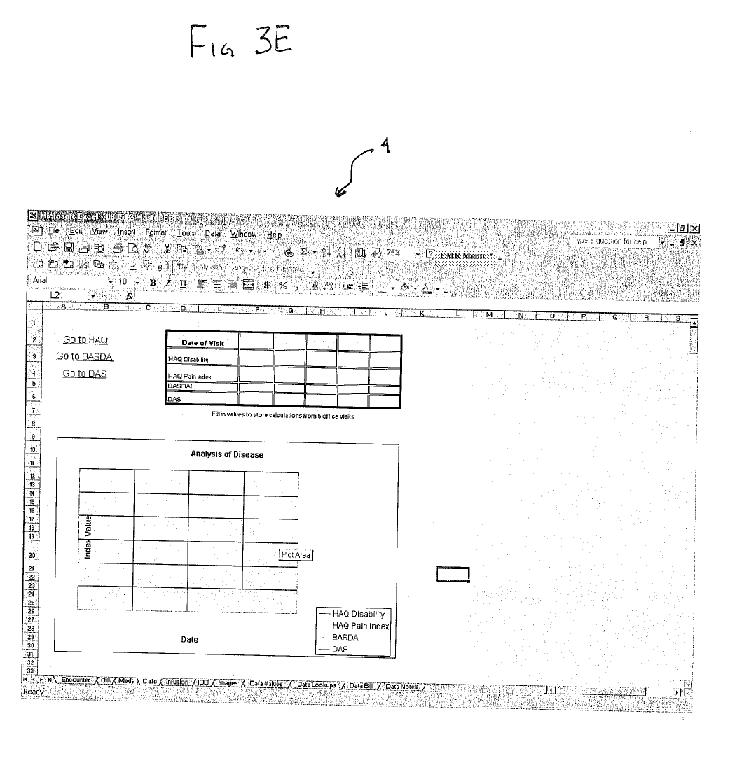

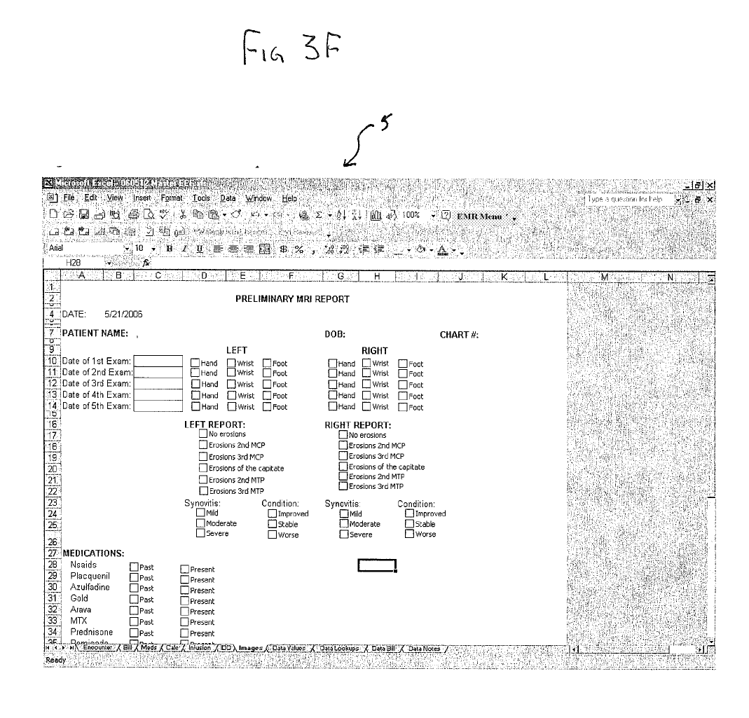

Implementation of an electronic medical record system according to the invention requires two preliminary steps. The first is creation of forms in a spreadsheet software, typically Microsoft Excel, with the same or substantially similar appearance to paper forms utilized in a physician practice. The particular order of the data fields in the spreadsheet version of forms makes no difference to the operation of the EMR system since the fields can be tagged with data type identifiers similar to the process utilized in extensible markup language (XML), and thus the electronic forms utilized in the current EMR system will appear familiar to the staff of a physician's office, while not affecting the operation of the EMR system. The second preliminary step is the installation of an EMR system add-in to the practice's spreadsheet software, typically an add-in for Microsoft Excel. It will be understood that the invention may be implemented on a variety of spreadsheet software, however due to the present prevalence of Microsoft Excel in this software category, Excel will be utilized for the descriptions and examples herein. Folders for master templates and patient charts are created on the hard drive associated with a computer in the physician practice. The usual configuration of a physician practice is a local area network having up to several dozen work stations with a gateway connected to the Internet. The master templates folder holds files representing the current versions of documents illustrated in FIGS. 3A-3F, for instance, including a master patient chart file. The patient chart files are also referred to herein as patient EMRs, or patient master EEF files or EEF.xls files.

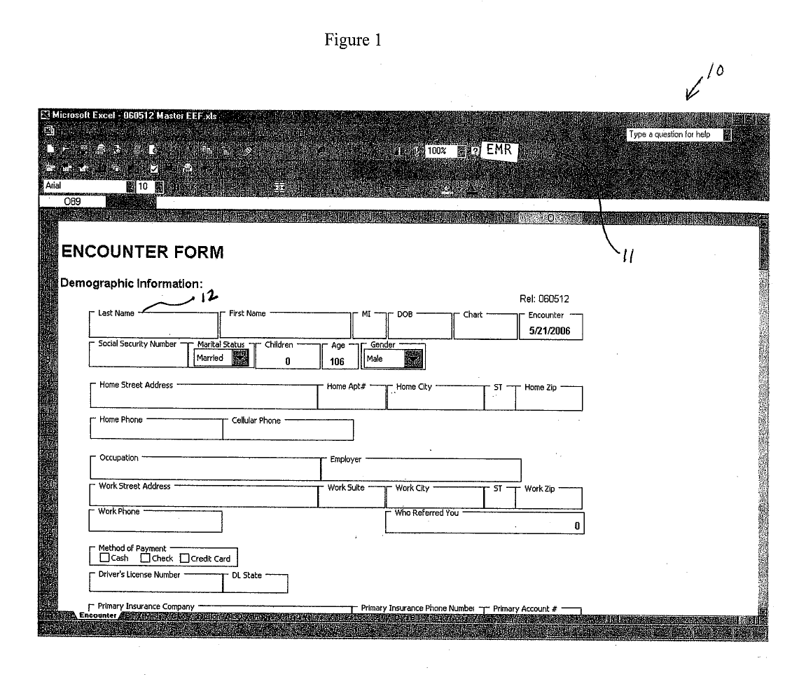

Turning then to FIG. 1, a typical patient encounter form 10 is illustrated with a number of fields such as “Last Name” field 12 to be completed. The last name field is tagged with a data type identifier (NR_PATIENT_LAST_NAME) so that when the electronic medical record created by completing this form 10 is processed, the data in “Last Name” field 12 will be recognized and treated as a name. Similarly, data in other fields, such as Social Security Number, Home Phone and Occupation, is tagged and may also be processed properly irrespective of the ordering of the data on form 10 by parsing both the data in the field and the associated tag.

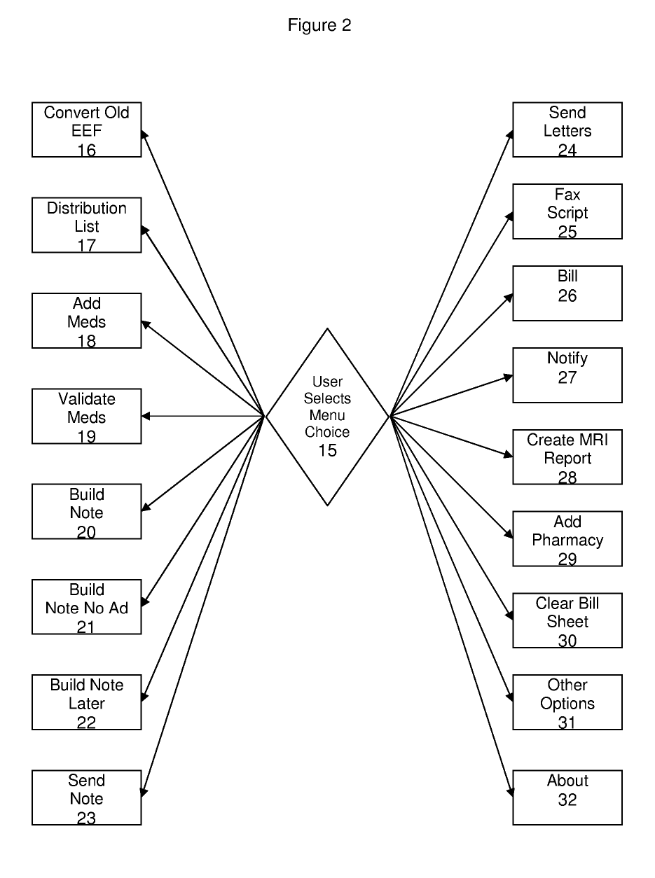

Installation of the EMR system add-in for Excel results in the addition of a menu 11 to the Excel command bar. The menu 11 is operable when a new or existing patient record is open in Excel. FIGS. 2 and 3A illustrate exemplary menu choices presented to user and the initial action of user selecting the menu 15. While each of these menu options will be explained in greater detail below, briefly the Convert Old EEF option 16 implements the conversion of an old patient chart into a newer format. The Distribution List option 17 provides a listing of doctors, pharmacies, insurance companies, laboratories, and other third parties that might need to receive patient health or billing information to be added to the patient's chart. The Add Meds option 18 allows a user to record the prescription of a new medication into the patient's chart. The Validate Meds option 19 allows a user to check against a rules database to determine whether a new medication is appropriate for the patient. The Build Note option 20 combines patient information from a patient chart record with standard templates to produce a word processing document such as in Microsoft Word, containing prose presentation of information with minimal user effort. The Build Note No Add option 21 provides the same functionality of Build Note option 20 but without an embedded EMR system advertisement. The Build Note Later option 22 will build a note at a later specified time. Send Note option 23 allows a user to transmit a word processing note to any doctor, pharmacy, insurance company or other party on the distribution list of the patient's chart. The Send Letters option 24 combines data from a patient's chart with letter templates to produce a word processing document in the form of a letter rather than a note, and the letter may be sent to any of the parties entered on the distribution list of the patient's chart.

The Fax Script option 25 will send a fax communication of prescription information to pharmacies or other contacts entered on the patient's chart. The Bill option 26 allows a user to enter billing data and cause another software module or Excel script to enter the billing data into third party billing and accounting software such as Medical Manager and Quick Books. The Notify option 27 distributes a document to a list of printers, thereby alerting staff to pending work requiring their efforts. The Create MRI Report option 28 allows a user to create an MRI report with a digital MRI image. The Add Pharmacy option 29 allows a user to add a pharmacy's contact information to entries accessible through the Distribution List option 17, and to a patient's chart. The Clear Bill Sheet option 30 allows a user to clear previously selected options within the patient's billing information. The Other Options 31 indicates expandability of the EMR system to accommodate additional features and the About option 32 displays contact, version, patent, copyright and other information about the EMR system vendor and the EMR system software.

The EMR system utilizes a master record referred to as a patient chart or a patient Master EEF.xls in Microsoft Excel, to capture, store, and manipulate patient data. Within the master record are a collection of specialized documents such as a patient encounter form (FIGS. 1 and 3A) to capture, store, organize and manipulate patient information collected during a medical interview; a bill sheet 2 (FIG. 3B) to capture, store, organize and manipulate patient billing information; a meds sheet 3 (FIG. 3C) to create a digital prescription that could be transmitted to a pharmacy; a calc sheet 4 (FIG. 3E) to use to conduct a health assessment questionnaire; x-ray and MRI report 5 (FIG. 3F) to capture, store, organize and manipulate patient MRI and x-ray information; a variety of specialized forms applicable to a particular physician practice such as an Infusion Flowsheet 6 (FIG. 3D) or an IDD report to capture, store, organize and manipulate patient infusion or intervertebral differential dynamic information.

In an exemplary embodiment of the EMR system, a data values form is used to store Boolean information relative to the population of fields in other data forms; Data Lookup and Data Notes forms are utilized to record the field tags so that the spreadsheet operates easily for reporting and manipulation purposes; and a Bill Data form contains Boolean information related to bill sheets. These forms are not visible to the typical user but supply information utilized by software routines or Excel scripts related to data entered on the user accessed forms typified by FIGS. 3A-3F.

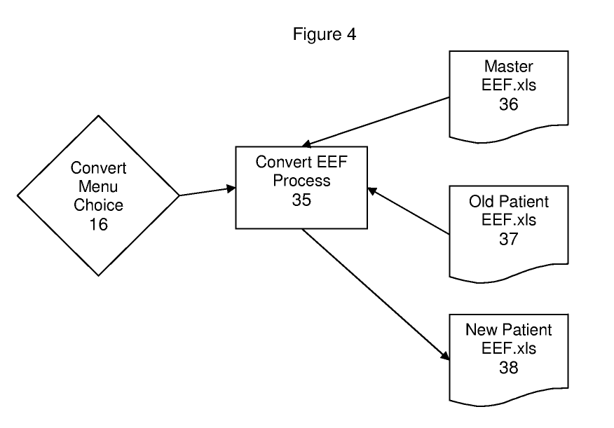

Turning then to the specific functionality of the illustrated EMR system menu, the Convert Old EEF option 16 provides for an efficient method of updating EMRs on an as-needed basis. Modern medical practice often requires additional information to be collected, or information to be collected in an altered fashion, so that one or more of the forms within the Master EEF must be revised. This modification process for master forms is initiated by the physician practice requesting, or governmental agency or payor requiring, a modification to the Master EEF format. When the New Master Record format is implemented, it is not necessary to run an update process on the entire set of patient records. In fact, in some types of physician practices, such as in specialized surgical practices, there is a relatively low percentage of repeat patient business, so that updating all patient charts in old record formats is not likely to be useful. Furthermore, changes may occur on a daily or weekly basis at some times so that several changes to the master record format may be implemented in-between regular patient visits. Accordingly, when a patient returns to the practice after an update of the Master EEF format, it is possible to update that patient's record on an ad hoc basis. By opening the Old Format patient record 37 and selecting the Convert Old EEF option 15, as shown in FIG. 4, the Convert Old EEF script 35 loads the current Master EEF file format 36 and the old patient EEF file 37 and updates the old patient record 37 into a new patient EEF file 38 in the new format. This provides a mechanism for updating patient records on the fly rather than installing new releases that update all patient records. The processing power required to update individual patient records is minimal and does not take the EMR system out of operation. Furthermore, physician schedules for the next day may be entered into the EMR system each evening and the Convert Old EEF script 35 run on all of the scheduled patients' records during the evening.

The Distribution List option 17 imports the physician practice's contact list 40 and displays 41 those contacts to the user. The user may select contacts to add from a physician list 42 and/or a pharmacy list 43, or other types of contacts and select from fax or email methods of transmission 44. When selections are complete, the selected contacts and transmission methods are stored in the patient's chart 38. If the Distribution List option 17 is run in connection with a particular document, the applicable patient document may be transmitted to the selections from the list. This process 17 facilitates the transmission of data in electronic form and minimizes both delay in transmission of information and the creation of excess paper in typical physician office processes.

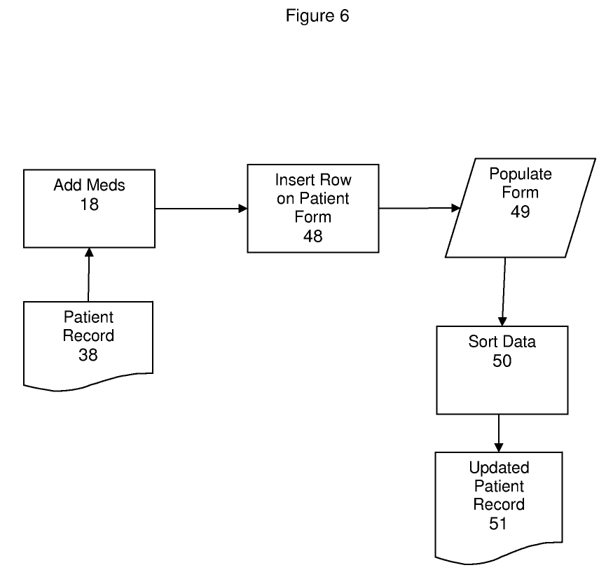

FIG. 6 illustrates the operation of the Add Meds option 18 which is implemented by selecting the Add Meds button from menu choices 15. Upon selecting Add Meds 18, the patient's EMR 38 is opened and a row is inserted 48 on the meds form within the Master EEF. An Add Medications data entry form is displayed to a user who manually types in the medication data. This data includes the medication and dosage, as well as the problem or symptom for which the medication is prescribed. The script then populates 49 the inserted row of the patient med sheet within the Master EEF from the data entry, sorts the data 50 within the form, and then saves an updated patient record 51. The process of updating medications for a patient may also generate a To-Do list entry for a staff person with medication oversight to pursue the Validate Meds option 19, or may flag the patient chart 38 for Validate Meds processing as a part of the oversight system updating processes.

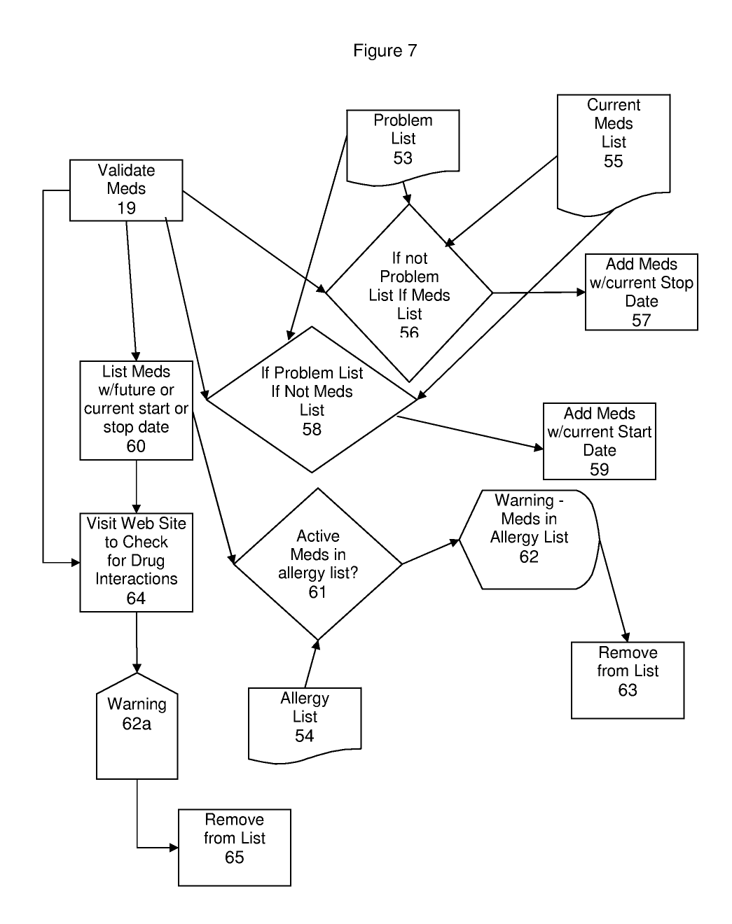

Implementation of the Validate Meds option 19 allows a user or automated script to check the appropriateness of prescribed medications, and the availability of medications for prescription. The Validate Meds option 19 is intended to operate not only upon new medications added by a particular physician practice group, but also to compare with medications the patient may be taking as a result of other conditions. Thus, medications are listed based not only upon new prescriptions, but also to existing medications identified in patient interview, appraisal and encounter sessions. As shown in FIG. 7, upon selection of the Validate Meds option 19, the validate meds process imports the previously known medications as a current meds list 55, and imports a list of conditions or symptoms warranting medication as a problem list 53. If the medication being validated appears on the current meds list 55 but the condition or problem for which it is prescribed is not on a problem list 53 for the patient, then Validate Meds allows the addition of the medication 57 to the patient's chart with an indication that the term of the medication has ended. If the patient's symptoms or condition does appear on the problem list 53 but the medication is not on the current meds list 55, then the medication is added to the patient's chart with a current start date 59 and the medication is added to the current meds list 55. The script then creates a list of medications with current or future start/stop dates 60 and proceeds to compare the medications in the list to an allergy list 54 on the patient's chart in step 61. If a match is found in the allergy list, then a warning 62 is displayed and the user is prompted to remove meds from the patient's current meds list 63. In addition, the meds with future or current start or stop date are transmitted to drug conflict website to check for drug interactions 64. In the event that interaction is disclosed, a drug interaction warning 62a is displayed and user is prompted to remove medication from list 65. Generally, removal of a drug identified as having the potential for allergic reaction or drug conflict is left to the discretion of the reviewing user in light of the severity of the possible negative reactions and the drug's likely benefits.

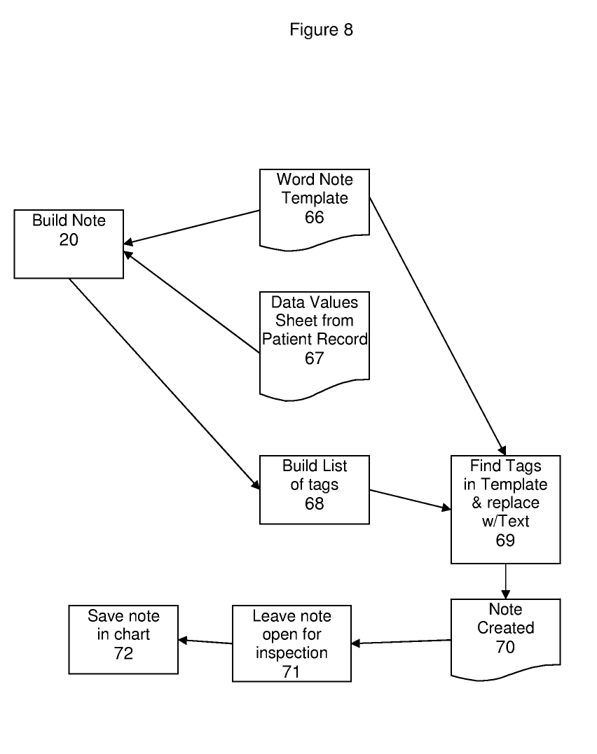

FIG. 8 illustrates the process of building a note for a patient record. A typical note will be a summary of a patient visit that is intended to be sent to the patient's other treating physicians outside the practice. When the Build Note option 20 is selected, a note template 66 is loaded, typically prepared in Microsoft Word format. The Boolean information concerning the population of data fields in the patient record is also accessed 67, and next the process builds a list of XML-like tags 68, locates corresponding tags in the note template 66, and replaces the tags with text 69 to create note 70. The user is allowed to inspect the note and make necessary edits 71 and finally the note is saved in the patient's chart/master EEF file 72. Only slight variations are involved in the Build Note No Add option 21 where the default promotion for the EMR system vendor or an associated business is omitted from automatic inclusion in the note, and for the Build Note Later option 22 which establishes a future time at which the Build Note process will be invoked.

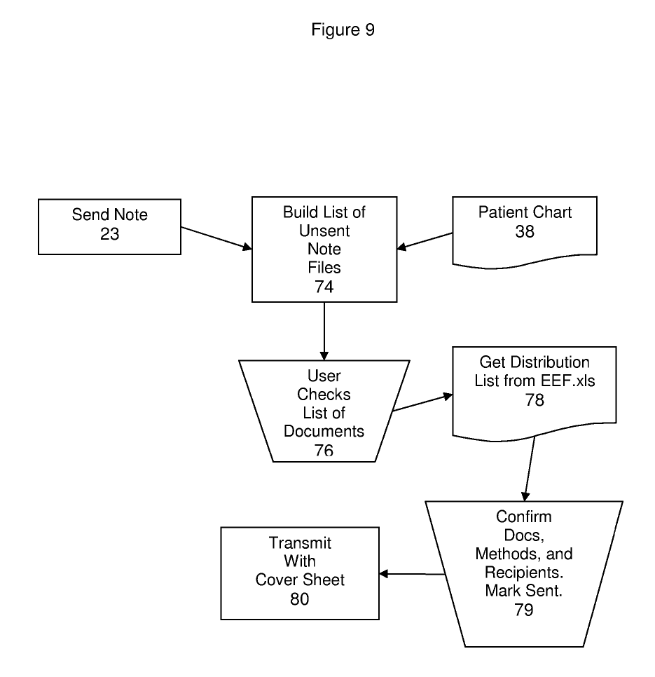

FIG. 9 illustrates the steps of the Send Note option 23. This process allows a user to send a note attached to a patient's record electronically. Upon selecting the Send Note option 23, the patient's chart 38 is processed and a list of note type files that have not been marked as “sent” are identified and a list built of those note files 74. Representative processes of marking a note file as sent could be either by including a sent data field associated with the note or by renaming the note file to add “sent” to the file name. The user reviews the list of unsent notes to select one or more documents to be transmitted 76. The user also selects one or more recipients from the distribution list in the patient's chart 78. The user then confirms the documents to send, the method of transmission, and the recipients 79. Upon confirmation, the record is updated to include the designation that the note is sent and the note is transmitted with a cover sheet by fax or by email if desired 80. It can be seen that the Build Note 20 and Send Note 23 options provide a powerful communications tool. A patient may be undergoing treatment for several conditions simultaneously from several specialists, for instance a combination of diabetes treated by an endocrinologist, cardiovascular disease treated by a cardiologist, and a degenerative spine condition treated by a neurosurgeon. Utilizing the Build Note 20 and Send Note 23 options after a patient visit to the endocrinologist, the patient's cardiologist and neurosurgeon in separate physician practice groups can be provided with electronically transmitted notes of the patient visit before the patient has even left the endocrinologist's office building.

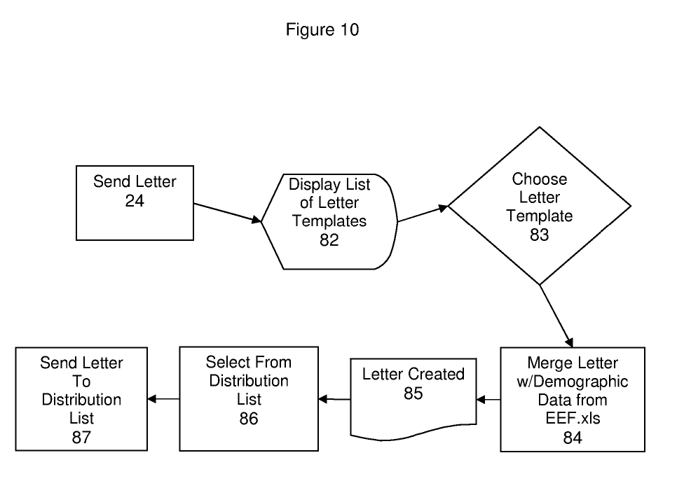

FIG. 10 illustrates the steps of the Send Letter option 24. Selecting the Send Letter option 24 prompts the display of a list of letter templates 82. This will allow the user to create and send a letter with minimal effort. The user chooses a letter template 83 according to the nature of the desired correspondence. Next, the Send Letter script merges data from the client's Master EEF file with the selected letter template 84 to create a letter 85. The letter is left open so that it can be edited. The user selects recipients from the distribution contacts listed 86 on the patient record to determine the routing of the letter and finally, upon confirmation, the letter is sent to the contact or contacts chosen from the distribution contacts list 87.

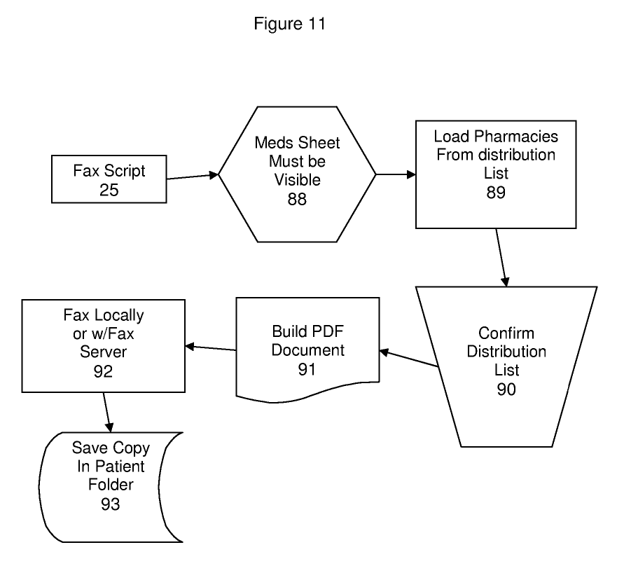

FIG. 11 shows the steps of the Fax Script option 25. This process allows the user to fax prescription information to pharmacies directly from a patient's EMR. Prior to selecting the Fax Script option 25, a patient's meds sheet 3 (See FIG. 3C) should be selected and displayed 88. Next the Fax Script process lists the pharmacies from the patient's distribution contacts list 89 and the user must select and confirm the pharmacy to whom the prescription is to be sent 90. Upon confirmation, the process builds a faxable electronic document such as .pdf formatted document 91, and while that document may be printed and faxed manually, it is preferably directed in electronic form to a connected fax line or to a fax server 92 for transmission to the pharmacy and a copy of the document is saved to the patient's Master EEF file 93. Preferably, the process of building a faxable electronic document incorporates a photograph of the patient from the patient's med sheet which enables the receiving pharmacy to easily verify that a prescription is being picked up by the designated patient.

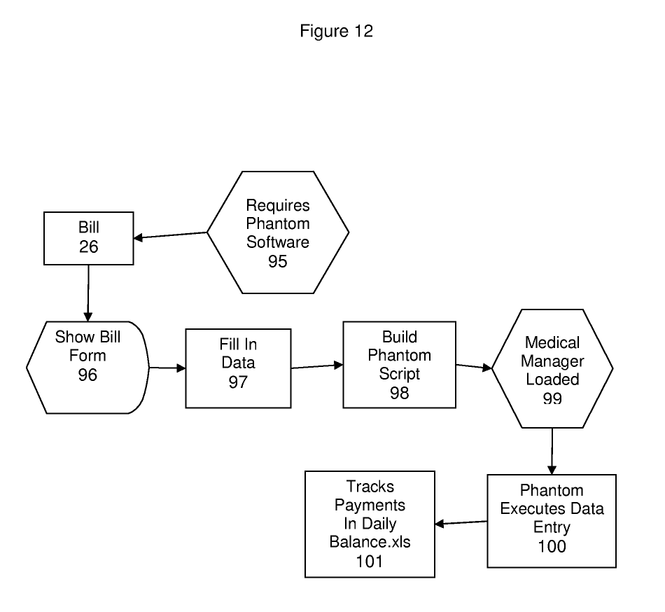

The Bill Option 26 is illustrated in FIG. 12 and utilizes phantom data entry software 95 to facilitate the interface of the EMR system with third party billing software, typically Medical Manager. The Bill Option 26 is selected to allow the user to produce a bill for services rendered to a patient. The Bill Option 26 produces a display of a bill form 96 and the user is prompted to fill in data 97 into the form. The bill process then runs the phantom data entry software which removes mouse clicks and keystrokes from the data and assigns XML-like data characteristics to the data that has been input into the bill form, or gathered by the script from Data Values sheets in the patient's chart. The third party billing software, typically Medical Manager, is loaded 99 and possibly third party accounting software such as Quick Books, and the phantom script executes and effects data entry into the third party accounting and billing software 100 and tracks payments against billings in daily balance spreadsheet 101. The third party accounting and billing software is utilized to produce financial reports.

The Notify option 27 is utilized to alert staff members of a physician's office to pending work. The process can be implemented to some extent utilizing simply the patient bill sheet (FIG. 3B) that should be marked with the desired laboratory and x-ray work. Then when the notify process 27 produces a list of all network printers 103, the user will choose the printer on the list 104 where the work is to be performed and a copy of the bill sheet will be sent to the printer 105. When the document is printed, the staff is alerted to new laboratory or imaging work 106 is needed for the patient. Of course, instead of merely utilizing the bill sheet to order laboratory work, notes can be composed and sent for other types of required services and data may be transmitted not only by printing at a particular location, but also by emailing or sending SMS text messages to users via computers or cell phones.

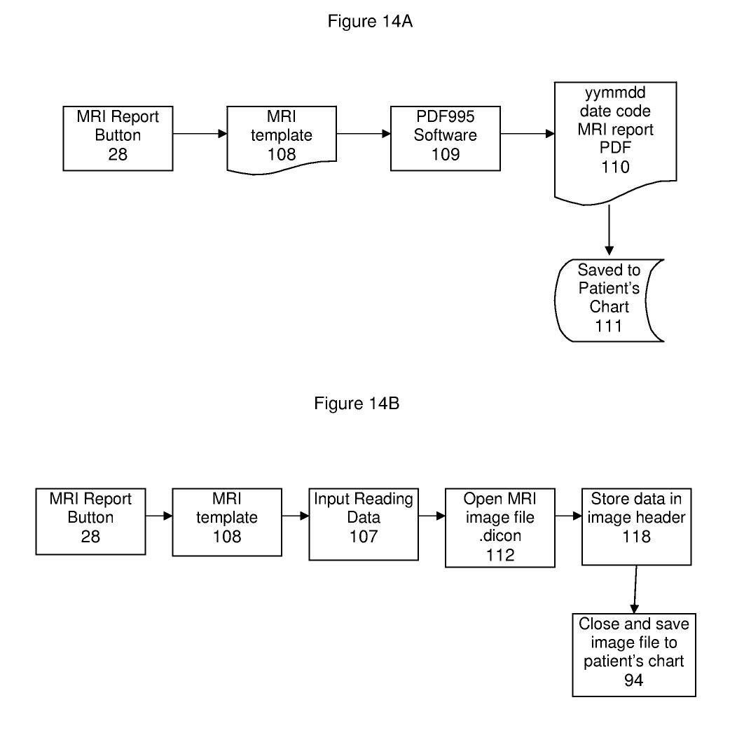

The process followed when the Create MRI option 28 is selected is illustrated in FIG. 14A. A substantially similar process is followed when dealing with x-rays. The Create MRI process 28 allows a user to create a .pdf file of the MRI reading with a description of the image such as “left anterior forearm” together with other bibliographic data and the radiologist's observations about the image. Upon selecting MRI Report option 28, an MRI template document 108 is loaded. The user may access digital image of the MRI and then complete the MRI template with the appropriate data. The completed MRI template is then converted to a note in printable electronic format such as .pdf 109 and the note and image files are appended with date code 110 and saved to the patient's Master EEF file 111.

A preferred variation of the Create MRI option 28 is illustrated in FIG. 14B where, just as before, selecting the option loads an MRI template 103 and the user completes the template with the appropriate data 107. This data input should not be duplicative of information in the patient chart, as that data may be imported by running a script. Instead, the data will generally include a description and radiologist's interpretation of the image. When images are in .DCM (The Digital Imaging and Communications in Medicine (DICOM) standard for distributing and viewing any kind of medical image regardless of the origin.) file format, or a similar format that combines both the image and a data header in one file, the image file may be opened 112 and the description and radiologist's interpretation entered within the header 118. The combination image file is then closed and saved to the patient's chart 94. The user may create a separate note containing the bibliographic data and description and radiologist's interpretation at this time, but preferably a script will run later, as in the evening, and review new image file headers and extract the necessary data to create a note associated with the image file. By using a combination image file with a file header containing bibliographic data and radiologist's interpretation, the image is never separated from the reading and the need for later re-interpretations of the image is minimized.

The Add Pharmacy process 29 allows the user to add pharmacy contact information to both the patient's chart and the physician practice's directory. Selecting the Add Pharmacy option 29 loads a contact information form 113 to the screen. The user must then manually complete the pharmacy's contact information 114. Then the Add Pharmacy script saves the information in a standard contact file format 115 such as Microsoft Outlook's .vcf or V-card format and adds the pharmacy contact information to the patient's chart. The Add Pharmacy process also emails the contact record to a user in the physician's office 116 where the user may manually add the file to Microsoft Outlook or other email software contact list 117 maintained on a practice wide basis.

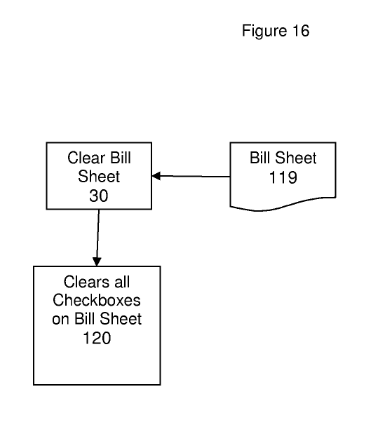

The Clear Bill Sheet process 30 automatically clears previously checked boxes on the bill sheet in the patient's chart. This process is simply illustrated in FIG. 16 where selecting Clear Bill Sheet option 30 loads the bill sheet 119 and clears all the previously selected check boxes on the bill sheet 120. This process is preferably run before a patient's return visit so that a cleared bill sheet 2 is available for each new appointment.

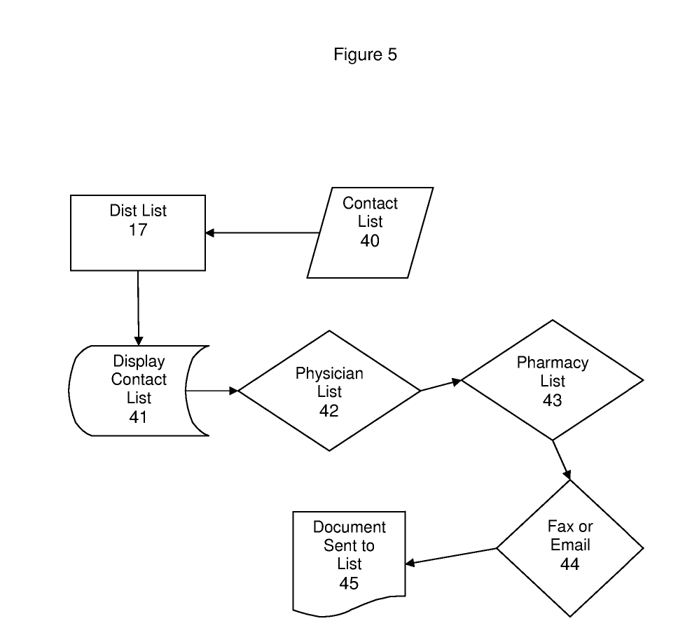

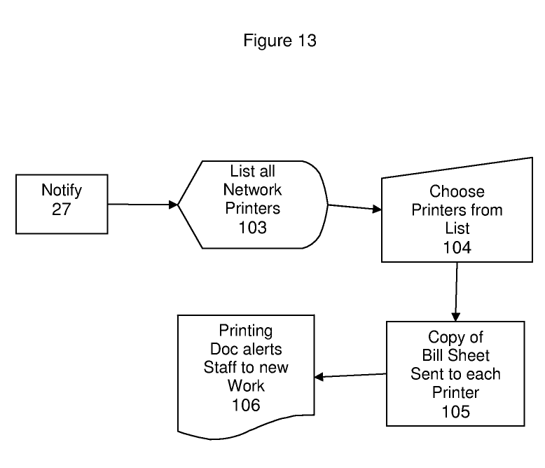

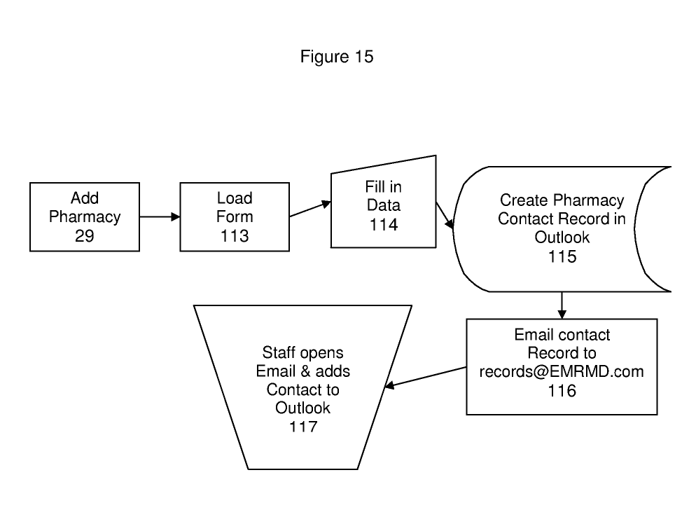

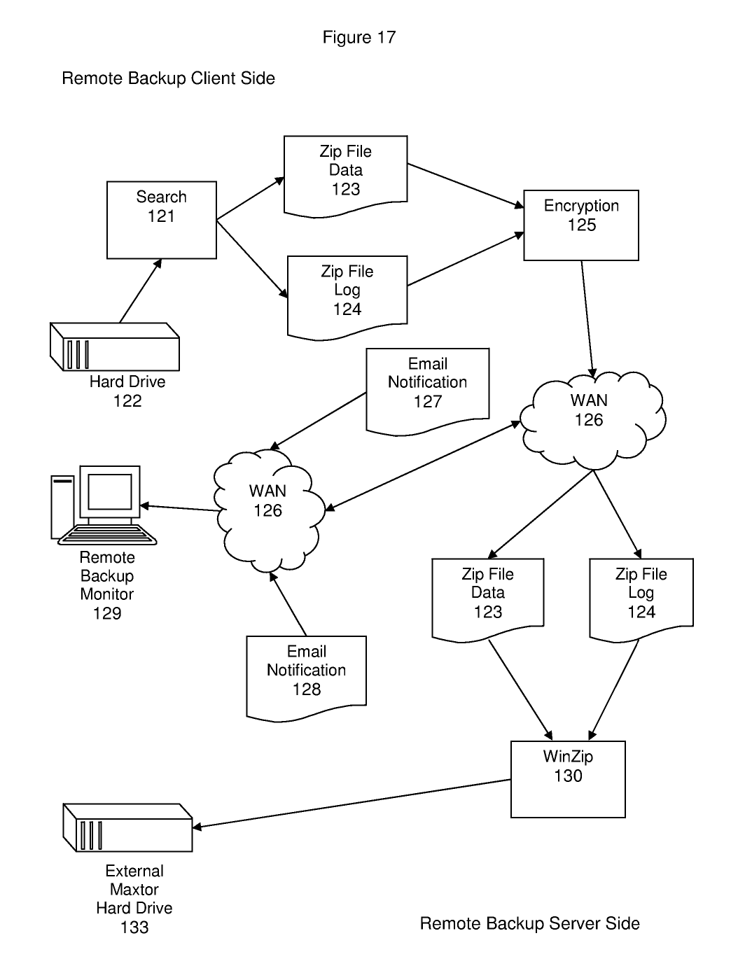

The foregoing FIGS. 4-16 illustrate processes for the administration of patient records in a physician's office. The following discussion relates to additional processes of a less-routine administrative nature or for interfacing the EMR system in a physician's office with third party sites to backup, store or acquire information. Turning then to FIG. 17, an illustration of the implementation of a remote backup process is presented. The remote backup process should run automatically in the evening to transmit a backup copy of a physician office's EMR system data to a remote site. In the physician's office, the preferred storage structure is for all patient records to reside on a single work station or server. This allows the hard drives 122 of such work station/server to be easily searched 121 for files that have been altered since the last backup. The backup process preferably produces a zip file containing compressed data 123 and a log file 124. These files are preferably encrypted 125 and transmitted over the Internet 126 to a remote backup computer controlling a data storage device, such as a remote hard drive 133. Upon successful completion of the transmission of the encrypted updated files, the physician's office system produces an email notification 127 which is transmitted over the Internet 126 to a remote backup process monitoring station 129.

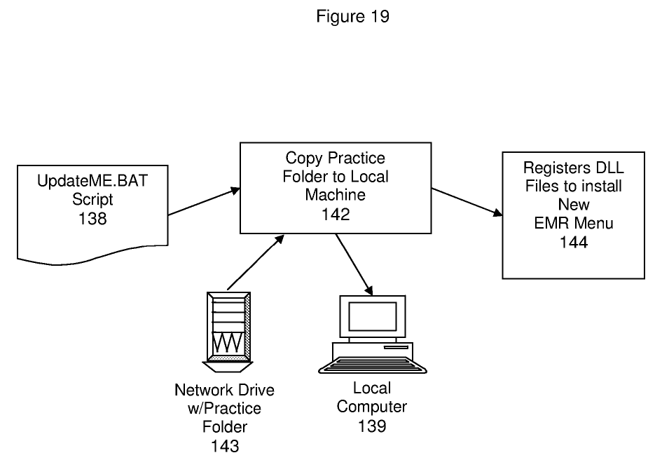

At the remote backup computer location, the transmission is unencrypted and the data 123 and log 124 files are decompressed 130 and stored to remote hard drive 133. Upon completion of the backup process, the backup location generates a success or failure email 134 which is transmitted over the Internet 126 to the remote backup process monitoring station 129. The end result is a mirror of the physician's office EMR data on a remote hard drive 133. If the remote hard drive is an external plug and play drive, in the event of failure in the physician's office, it is necessary only to deliver the backup hard drive 133 to the physician's office location and plug it into a production computer effectively replacing the local hard drive 122, and restoring operability to the EMR system. The process of updating the EMR system with new patient chart forms and other revisions operates in a very similar fashion, but in reverse with the physician's office being the recipient of updated formats and scripts, these being installed by running an update script as described below in connection with FIG. 19.

If the monitoring station 128 does not receive e-mail notifications 127,128 of successful transmission and receipt of back up data, then an exception report is generated and a service follow-up initiated to determine the cause of the failure. Preferably, the e-mail notifications 127,128 may contain some status information to assist in the determination of the reason for the back-up failure.

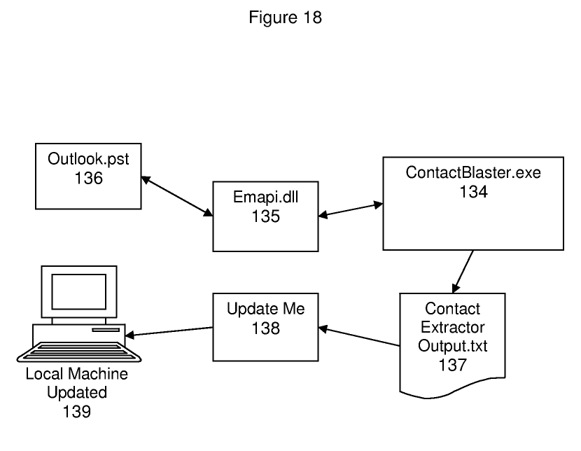

FIG. 18 is a process diagram showing a method for distributing updated contact information to a computer's local network in a physician's office. A script 134, commonly referred to as Contact Blaster, utilizes a .dll file 135 to monitor email software 136 for updated contact records. When updated contact records are detected, it creates a new file 137 containing the updated contact information. Then an update script 138 is executed and uses this file to update contact information on all workstations 139 on the local network. FIG. 19 illustrates the execution of the update script 138. This update script updates all computers within a physician's office on the local area network with new spreadsheets, contact files and other information. The update script 138 runs on each local machine 139 on the local area network. The script copies the practice folder 142 from the principal patient EMR file server 143 to each local machine 139. The practice folder contains all updates to the EMR system as well as the updated contact information. The script registers new .dll files and installs any updates to the EMR system 144.

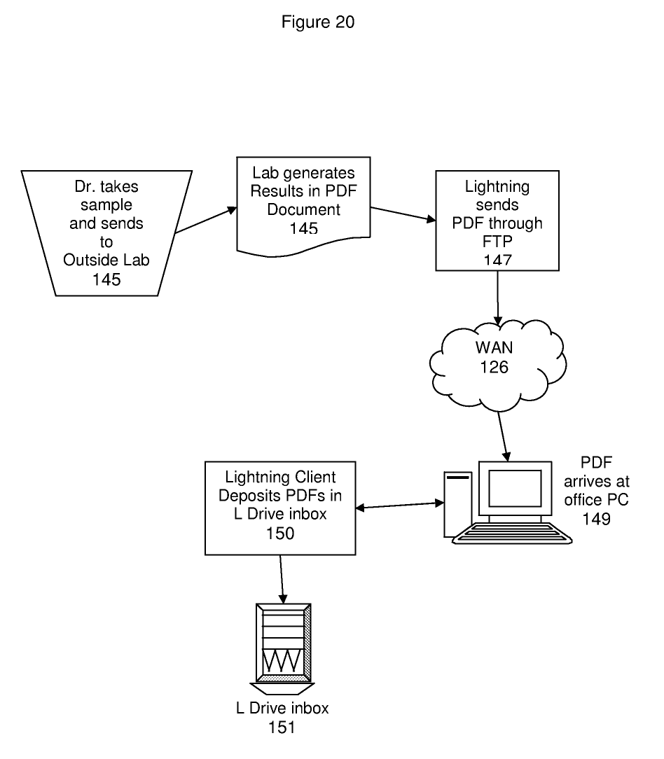

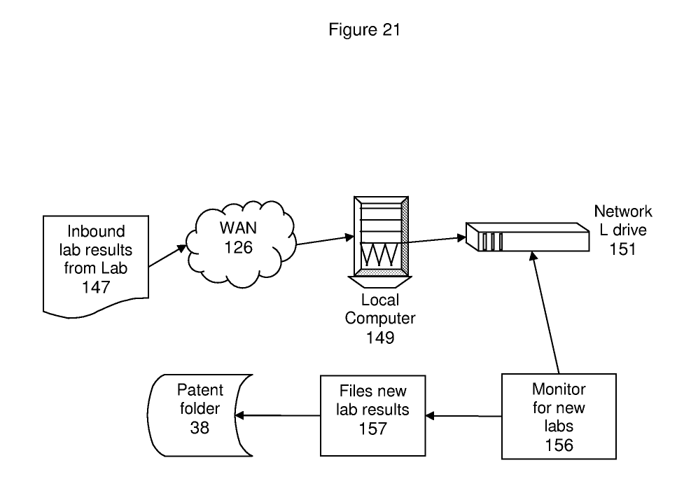

FIGS. 20 and 21 illustrate the processing of lab results from an outside laboratory service which are transmitted to a physician practice. For instance, in connection with lab work, a physician will direct a sample be sent to an outside lab 145. The lab may either send a fax or email a .pdf document of lab results 146. Preferably communication software 147 will coordinate the transmission of electronic documents from the lab through Internet 126 to a physician office workstation 149. The communication software client on the physician office workstation will then transfer the documents 150 to an electronic inbox 151 where the individual lab reports are associated with the appropriate patient chart. Thus, as shown in FIG. 21 when inbound lab reports 147 arrive over the Internet 126 to local computer 149, those reports are stored on the local EMR system drive 151 and a script 156 monitors the drive for new lab reports. When practicable, lab reports are scanned for optical character recognition or preferably in some .pdf formats the text may be read directly and the reports are automatically filed 157 in the patient charts that correspond to a recognized name. Should no match with a patient name be found, an administrative user may be notified of the new lab report and prompted to manually review new lab results for filing in the appropriate patient folders 38.

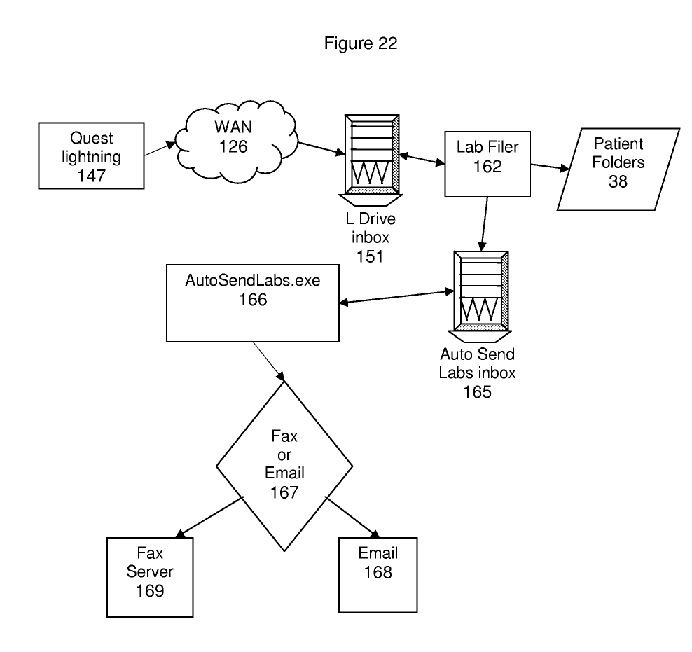

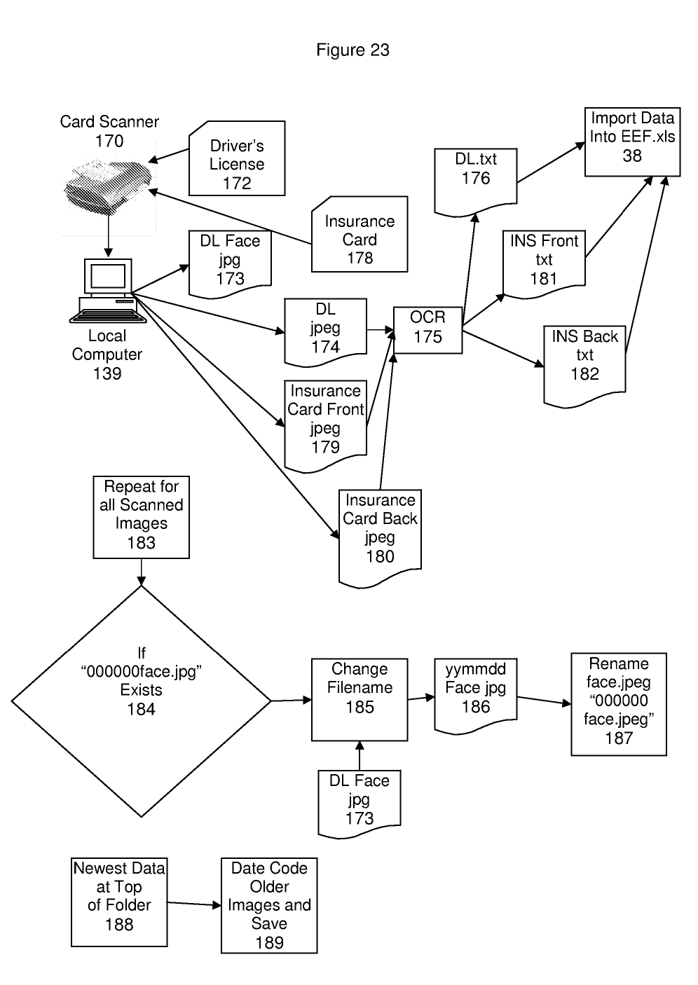

A further enhancement is illustrated in FIG. 22 where an auto send process allows lab results to be automatically transmitted to patients. When the lab document 147 is received over the Internet 126 by local EMR system drive 151, and automated lab filer 162 has associated the report with the patient folders 38 so that the report becomes a part of the patient's chart 38, simultaneously those lab reports are recognized for placement in the auto send inbox 165. The auto send inbox 165 is periodically monitored for new lab reports by script 166. When a new lab report is located, the script determines whether the patient has requested a fax or email reporting 167, and then emails 168 or forwards the document to a fax server 169 as appropriate for transmission to the patient.

It is also possible to only send normal lab results automatically instead of all results if preferred by a particular physician practice and permitted by state law. This may be easily enabled for lab reports that are sent in color with a particular color, such as a red or pink, used to highlight any abnormal values in the report. The lab reports need merely be scanned to determine if any of the color indicating an abnormal result is present, in which case those reports may be withheld from the autosend procedure and instead be queued for a personal phone call to the patient preceding delivery.

An additional feature that may be implemented in the EMR system is a card scanner process. A system user can utilize a card scanner 170 to scan a patient's drivers license 172 and insurance card 178 and extract and store the data from those cards. The card scanner 170 is attached to a local computer 139. When the drivers license is scanned, the scanner extracts an image of the patient's face which is saved as a face image 173. An image of the entire drivers license is saved as a license image 174, and that image is processed by optical character recognition product 175, and the text from the drivers license image 174 is recovered and saved in a license text file 176. When the scan and recognition processes work properly, information from the license text file 176 is recognized and imported into the patient's Master EEF file 38, and need not be entered manually. The system user also scans the insurance card 178 and an image of the front of the insurance card 179 is created as is an image of the back of the insurance card 180. The insurance card images 179, 180 are processed by the optical character recognition process 175 creating a text file for the front of the insurance card 181, and a text file for the back of the insurance card 182. The recovered information from the insurance card is then imported into the patient's Master EEF file 38. It is also desirable to date code scanned images so that the most recent card scans and the newest data are at the top of the patient's file. So, for each face image, for instance, the process checks to see if there is a zero date face image 184. If such an image exists, then that pre-existing image is renamed 185 to include a current date code 186. The newest image is then assigned a zero date code 187 and placed at the top of the image stack. The older images are saved 189. As discussed above in connection with FIG. 11, it is desirable to save a copy of the current face image on the meds sheet 3 so that the image may be included on any prescriptions that are transmitted to pharmacies.

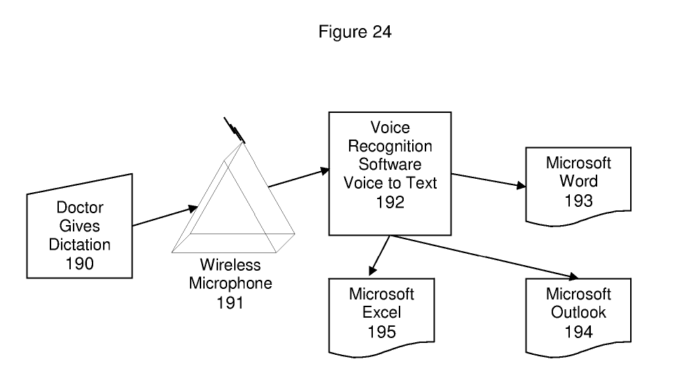

The EMR system may also be integrated with voice recognition software as illustrated in FIG. 24. So in this simplified illustration, if the doctor gives dictation 190 in his office, he may use a wired or wireless microphone 191 to capture dictation and transmit it to a computer running voice recognition software trained to the doctor's speech which will convert voice to text 192 for use with word processing 193, email 194 or spreadsheet 195 software. Because a doctor typically gives dictation in rooms other than the office housing the computer with voice recognition software trained to the particular physician's speech characteristics, two mechanisms are utilized to enable the physician to dictate throughout the office. One part of the solution to allow dictation outside the office housing the computer with voice recognition software trained to the particular physician's speech patterns is the use of a wireless microphone. A wireless microphone may transmit from several hundred feet to several hundred yards and may be routed to a particular computer on a local area network so that each physician's microphone communicates uniquely with the workstation trained to that physician's voice. The second part of the solution is the use of a remote desktop process so that a trained computer in the doctor's office operates a remote computer in the examination room where the doctor is dictating, so that the data and operations input by speech through the voice recognition software are processed by the trained computer but reflected on the monitor of the examination room computer. In this fashion, the physician can see the transcription in nearly real time and is visually prompted to correct and complete the dictation in the proper format. Implementation of a remote desktop process enables a physician to utilize any work station on the local network just as if it were the work station in the physician's office.

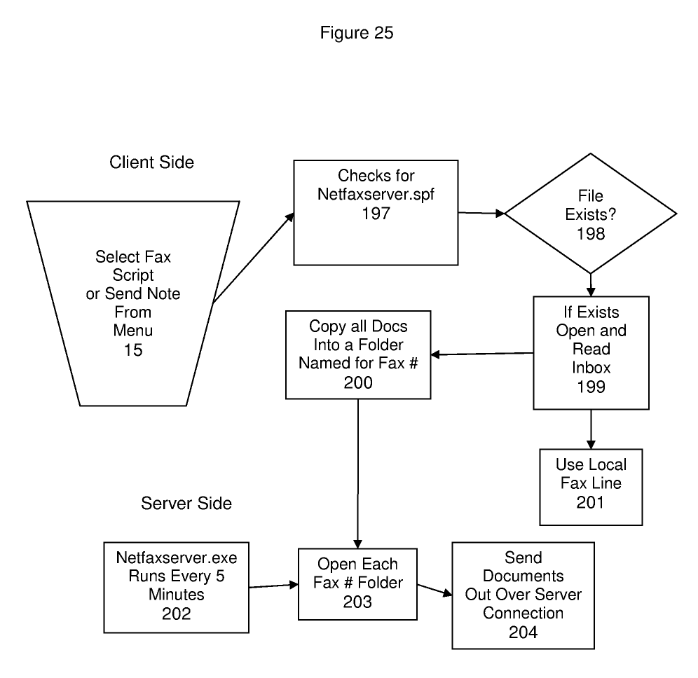

FIG. 25 provides a more detailed illustration of the process of faxing information from the EMR system. The fax server process allows computers on the EMR system to send a fax either over a local telephone line connection or through a fax server with a data connection. If a user selects a send note 23 or fax script 25 from the EMR system menu 15, the process checks for the presence of a fax server software preferences file 197. If this file exists 198, the process opens the file and reads the inbox 199 and then copies all documents into folders named for the corresponding fax number to which they are addressed 200. In the absence of fax server software, the user's workstation can use the local fax line to send and receive documents 201. On a computer serving as the fax server for the EMR system, monitoring software runs periodically 202, perhaps every five or ten minutes. This software will open each non-empty fax number folder 203 and transmit the documents in the folder and over the server's fax connection 204.

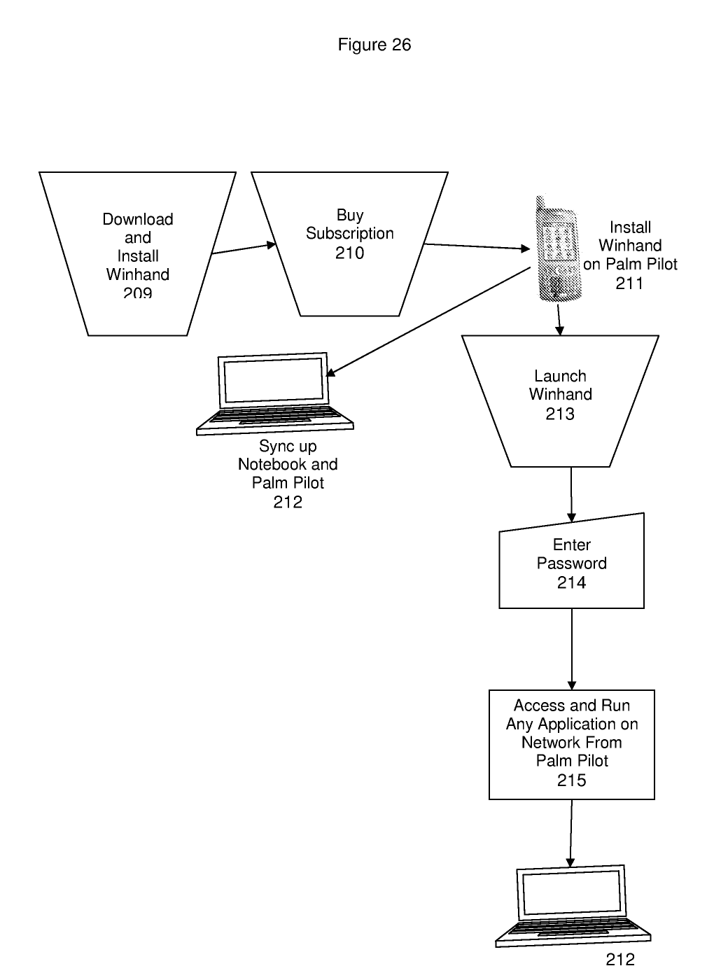

Another adaptation of the EMR system utilizing remote desktop process software enables the user to access and run programs from the office work station over a handheld device. FIG. 26 shows the implementation of this process on a palm pilot handheld device 211 utilizing Winhand software. Other handheld devices and their associated software products may also be utilized to achieve the same result. According to the specific illustrated implementation, the user must first install 209 and subscribe 210 to the Winhand software. This software is installed both on the computer 212 that is to be controlled by the handheld device and on the handheld device itself 211. After installing the software, the handheld device 211 and associated computer 212 are synchronized. Then the Winhand application may be launched 213 on the handheld device 211 to commence communications with remote computer 212, and upon entry of the appropriate password 214 or other security protocols, the user may access and run any accessible application on computer 212 from the handheld device 211. This handheld operation of a remote notebook or desktop workstation 212 is effectively a use of Winhand software to achieve remote desktop processing and effectively allows a physician access to his office computer over a handheld device.

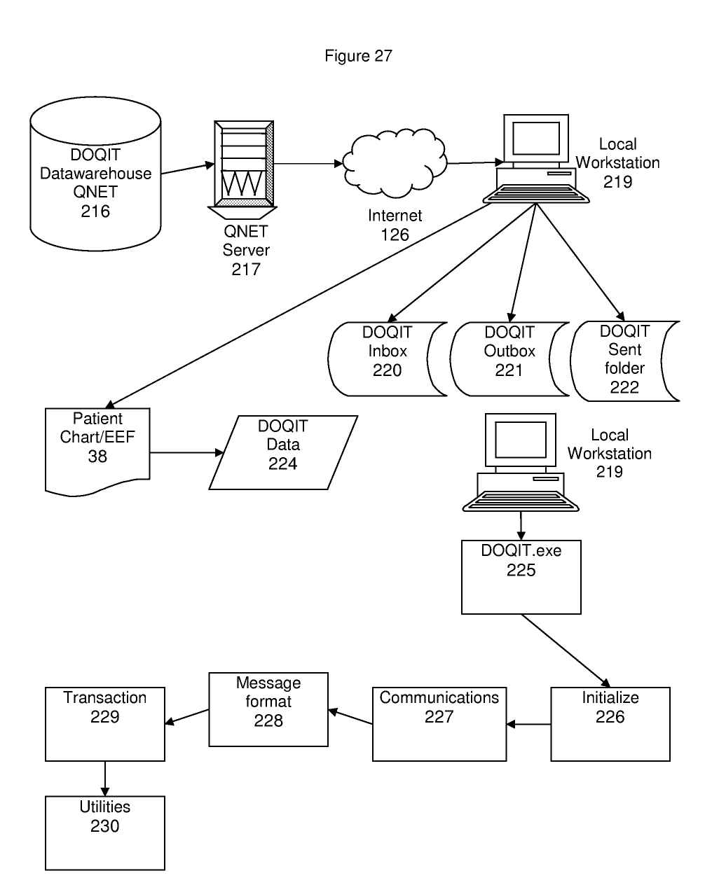

Finally, FIG. 27 illustrates the conduct of transactions over the Internet with Qnet. Qnet is the acronym for Quality Net Exchange which is a secure data interchange service and the only method of exchanging confidential information over the Internet presently approved by the Centers for Medicare and Medicaid Services. The object of the DOQ-IT script 225 in the EMR system is to allow communication of data with the Doctor's Office Quality Information Technology (DOQ-IT) data warehouse 216. The DOQ-IT data warehouse is an effort by the federal government to establish performance or quality criteria to be associated with physicians' reimbursements. A local work station 219 in the physician's office can connect with Qnet 217 over the Internet 126. The Qnet server 217 may in turn interface with the DOQ-IT data warehouse 216 which houses data according to DOQ-IT's required format known as HL7. By labeling the data fields in the Master EEF files of the EMR system, it is possible to communicate data between the patient's Master EEF files 38 on the local system and the HL7 format records in the DOQ-IT data warehouse 216. For the EMR system's DOQ-IT script 225 to enable this communication with the DOQ-IT data warehouse 216, the DOQ-IT script 225 is installed on a local work station 219 with a DOQ-IT inbox 220, DOQ-IT outbox 221, and DOQ-IT sent folder 222. Each patient's Master EEF file 38 also contains a tab 224 with DOQ-IT data. The DOQ-IT script 225 runs by first activating initialization module 226 that checks for all necessary files and folders for the script to run. The initialization module 226 creates any necessary files and folders if they do not already exist. The communications module 227 of the script 225 logs into the Qnet server 217 over the Internet 126 to enable communication of files between DOQ-IT warehouse 216 and local work station 219. The message format module 228 of the DOQ-IT script 225 opens batch files from the DOQ-IT inbox 220 which is populated with the new and updated files from the day's work at the physician's office. The transaction module 229 reads out the data from files in the inbox 220, converting appropriate information to DOQ-IT data from tab 224 of each patient chart 38 to HL7 data format and then closes the files and sends the HL7 format data to the DOQ-IT outbox 221. This HL7 format data is then sent from the DOQ-IT outbox 221 through Qnet 217 to the DOQ-IT data warehouse 216 and a copy is saved locally in the DOQ-IT sent folder 222 for archival purposes. The utilities module 230 of the DOQ-IT script reads and extracts data from the files at the DOQ-IT data warehouse 216, provides log information and supports other administrative functions.

All publications, patents and patent documents are incorporated by reference herein as though individually incorporated by reference. Although preferred embodiments of the present invention have been disclosed in detail herein, it will be understood that various substitutions and modifications may be made to the disclosed embodiment described herein without departing from the scope and spirit of the present invention as recited in the appended claims.

We claim:

1. A method for operating an electronic medical records system in a physician's office comprising the steps of:
a) providing a workstation operating spreadsheet software and office productivity software and having an associated data storage device;
b) providing a folder on the data storage device for the storage of patients' electronic medical records;
c) providing a template operable in the spreadsheet software for collecting patient data;
d) recording data from a patient encounter to create a patient electronic medical record; and
e) storing the patient electronic medical record in the folder.

2. The method of claim 1 wherein the appearance of the template is customizable to accommodate the preferences of each position office.

3. The method of claim 1 further comprising adding a distribution list selected from physicians, pharmacies, insurance companies, and laboratories to the patient electronic medical record together with a preferred mode of communication with each entity on the distribution list.

4. The method of claim 1 further comprising a method of updating a patient's existing electronic medical record created according to claim 1 prior to a subsequent patient encounter by calling a routine to convert only a selected pre-existing patient electronic medical record to the newer template format prior to such encounter.

5. The method of claim 1 further comprising adding medication data to the patient's electronic medical record and validating medications on the patient electronic medical record against patient conditions, allergies, and drug conflicts.

6. The method of claim 1 wherein the electronic medical records system includes a word processing template and the template may be opened and populated with data from a patient's electronic medical record to create a textual summary of a patient encounter.

7. The method of claim 1 wherein the patient's electronic medical record incorporates a photograph of the patient.

8. The method of claim 1 wherein a patient's insurance information is optically scanned into the patient's electronic medical record.

9. The method of claim 1 wherein a bill process operates by extracting data from a patient's electronic medical record and inputting that data into a separate billing software to create a patient bill.

10. The method of claim 1 wherein a medical image is included in the patient electronic medical record together with bibliographic data and radiologist's interpretation of the image.

11. The method of claim 10 further comprising the radiologist's interpretation is stored in a data header of a file format that combines both the image and data header in a single file.

12. A method for operating an electronic medical records system in a physician's office compromising the steps of:
a) providing a workstation operating spreadsheet software and office productivity software and having an associated data storage device;
b) providing a folder on the data storage device for the storage of patients' electronic medical records;
c) providing a template operable in the spreadsheet software for collecting patient data;
d) receiving lab results transmitted to the physician's office electronically and associating a lab report automatically with an existing patient electronic medical record.

13. The method of claim 12 further comprising providing a physician workstation operating voice recognition software in networked communication with a second computer operating a remote desktop process so that the physician's dictation to the second computer is processed by voice recognition software on the physician's workstation.

14. The method of claim 13 wherein the second computer is a hand held device.

15. The method of claim 12 wherein the electronic medical records system extracts data from patient electronic medical records and communicates data to the doctor's office quality information technology data warehouse.

16. The method of claim 12 further comprising the step of updating a patient's existing electronic medical record created according to claim 12 prior to a subsequent patient encounter by calling a routine to convert only a selected pre-existing patient electronic medical record to the newer template format prior to such encounter.

17. The method of claim 12 wherein a patient's information is optically scanned into the patient's electronic medical record.

18. The method of claim 12 wherein a medical image is included in the patient electronic record together with bibliographic data and radiologist's interpretation of the image.

19. A computer software product for managing an electronic medical records system in a physician's office wherein the computer software product comprises software instructions that enable a computer to perform predetermined operations and a computer readable medium bearing the software instructions, wherein the predetermined operations include:
a) implementing a user menu in spreadsheet software;
b) creating a folder on a data storage device for the storage of patients' electronic medical records;
c) providing a template operable in the spreadsheet software for collecting patient data;
d) updating a patient's pre-existing electronic medical record to current template format on an ad hoc basis prior to subsequent patient encounter by calling a routine to convert the existing patient electronic medical record to the current template format;
e) adding optically scanned data to the template;
f) recording data input pertaining to a patient encounter in the template operating within the spreadsheet software to create a patient electronic medical record;
g) displaying a contact list to a user and in response to user selections adding a distribution list selected from physicians, pharmacies, insurance companies, and laboratories to the patient electronic medical record together with a preferred mode of communication with each entity on the distribution list;
h) adding medication data to the patient's electronic medical record and validating medications on the patient electronic medical record against patient conditions, allergies, and drug conflicts;
i) adding a medical image to the patient electronic medical record together with bibliographic data and radiologist's interpretation of the image;
j) providing a word processing template and populating the word processing template with data from a patient's electronic medical record to create a textual summary of a patient encounter; and
k) storing the patient's electronic medical record in the folder.

20. A computer system for the operation of an electronic medical records system in a physician's office comprising a processor and memory for storing software instructions executable to instruct the computer to:
a) implement a user menu in spreadsheet software;
b) create a folder on a data storage device for the storage of patients' electronic medical records;
c) provide a template operable in the spreadsheet software for collecting patient data;
d) update a patient's pre-existing electronic medical record to current template format on an ad hoc basis prior to subsequent patient encounter by calling a routine to convert the existing patient electronic medical record to the current template format;
e) add optically scanned data to the template;
f) record data input pertaining to a patient encounter in the template operating within the spreadsheet software to create a patient electronic medical record;
g) display a contact list to a user and in response to user selections adding a distribution list selected from physicians, pharmacies, insurance companies, and laboratories to the patient electronic medical record together with a preferred mode of communication with each entity on the distribution list;
h) add medication data to the patient's electronic medical record and validate medications on the patient electronic medical record against patient conditions, allergies, and drug conflicts;
i) add a medical image to the patient electronic medical record together with bibliographic data and radiologist's interpretation of the image;
j) provide a word processing template and populating the word processing template with data from a patient's electronic medical record to create a textual summary of a patient encounter; and
k) store the patient's electronic medical record in the folder.
